(19) United States
(12) Patent Application Publication
(10) Pub. No.: US 2021/0326301 A1
(43) Pub. Date: Oct. 21, 2021

(54) MANAGING OBJECTS IN DATA STORAGE EQUIPMENT

(71) Applicant: EMC IP Holding Company LLC, Hopkinton, MA (US)

(72) Inventors: Pavan Vutukuri, Chelmsford, MA (US); Vamsi K. Vankamamidi, Hopkinton, MA (US); Philippe Armangau, Acton, MA (US)

(21) Appl. No.: 16/850,553

(22) Filed: Apr. 16, 2020

(51) Int. Cl. G06F 16/16; G06F 16/11; G06F 16/17; G06F 16/182; G06F 11/30

(52) U.S. Cl. CPC G06F 16/162; G06F 16/128; G06F 11/3034; G06F 16/1824; G06F 16/1734

(57) ABSTRACT

Techniques manage objects in data storage equipment. Such techniques involve receiving a request to create a new object for a particular object family (e.g., a collection of related data storage objects such as a production volume, snapshots, clones, snapshots of clones, etc.). Such techniques further involve deriving, for the particular object family, a total object count based on an active object count and a deleted object count for the particular object family. Such techniques further involve, in response to the request, performing an object management operation that (i) creates the new object when the total object count is less than a predefined total object count threshold and (ii) prevents creation of the new object when the total object count is not less than the predefined total object count threshold.

### BACKGROUND

A conventional data storage system maintains host data on behalf of a host computer. Along these lines, the conventional data storage system may write host data to a volume and read host data from the volume in response to host input/output (I/O) requests from the host computer. Additionally, the conventional data storage system may create snapshots and/or clones to provide access to older versions of the volume. Furthermore, the conventional data storage system may delete the snapshots and/or clones to free up storage space (e.g., for use by new snapshots and/or clones).

It should be understood that when the conventional data storage system deletes a snapshot or clone, the conventional data storage system may initially mark that snapshot or clone as having been deleted and then hide that snapshot or clone from the host computer. However, in order to prioritize computing resources for processing the host I/O requests, the conventional data storage system may postpone removing the snapshot or clone from storage until a future time when the data storage system is idle with respect to host I/O requests.

### SUMMARY

Unfortunately, there are deficiencies to the above-described conventional data storage system that postpones removing snapshots and clones from storage until a future time. Along these lines, such operation creates a debt or backlog of cleanup operations which the conventional data storage system must eventually perform in order to reclaim storage space for future use. If such debt accumulation is unlimited or uncontrolled, such debt accumulation may eventually interfere with certain operations such as mapping, metadata recovery, etc. Furthermore, such debt accumulation may cause breaking of child-parent link limits, problems with consistency check (e.g., fsck) times, memory shortages, and so on.

In contrast to the above-described conventional data storage system which suffers from a lack of control over debt accumulation (or backlogging) of cleanup operations, improved techniques are directed to managing objects within data storage equipment using a predefined object limit for an object family (e.g., a maximum number of data storage objects in the object family that may exist at any time). In particular, once the total number of data storage objects in the object family (e.g., a production volume, related snapshots, related clones, related snapshots of clones, etc.) reaches the predefined object limit, any further request to create a new data storage object in that object family is rejected by the data storage equipment. Accordingly, the amount of deletion processing for that object family is capped and the data storage equipment will not become overextended.

One embodiment is directed to a method of managing objects in data storage equipment. The method includes receiving a request to create a new object for a particular object family. The method further includes deriving, for the particular object family, a total object count based on an active object count and a deleted object count for the particular object family. The method further includes, in response to the request, performing an object management operation that (i) creates the new object when the total object count is less than a predefined total object count threshold and (ii) prevents creation of the new object when the total object count is not less than the predefined total object count threshold.

In some arrangements, the method further includes deriving the total object count includes:
(A) identifying, as the active object count, a first number of active objects of the particular object family that currently reside within the data storage equipment,
(B) identifying, as the deleted object count, a second number of deleted objects of the particular object family that currently reside within the data storage equipment, and
(C) aggregating the first number of active objects and the second number of deleted objects to form the total object count.

In some arrangements, the data storage equipment maintains a deleted object count table having deleted object count entries, each deleted object count entry of the deleted object count table (i) being indexed by a family identifier that uniquely identifies a respective object family and (ii) storing a respective deleted object count. Additionally, identifying the second number of deleted objects of the particular object family includes:
(i) identifying a particular deleted object count entry of the deleted object count table based on a particular object family identifier that uniquely identifies the particular object family among a plurality of object families within the data storage equipment, and
(ii) reading, as the second number of deleted objects, the respective deleted object count stored in the particular deleted object count entry.

In some arrangements, the method further includes updating the respective deleted object count stored in the particular deleted object count entry to indicate a current number of objects of the particular object family that have been deleted from a perspective of a host but that still await deletion processing within the data storage equipment. Accordingly, the even through the data storage equipment has effectively detected the object from the host's point of view, the data storage equipment is able to maintain a measure of remaining deletion processing work.

In some arrangements, the method further includes performing a deletion assessment operation that selects a target object family from the plurality of object families for prioritized deletion processing based on deleted object counts stored in the deleted object count entries of the deleted object count table. For example, the data storage equipment is able to identify where (i.e., a certain object family or families) deletion processing will provide the largest storage space reclamation benefit.

In some arrangements, the method further includes, prior to receiving the request to create the new object for the particular object family and prior to deriving the total object count, creating a production storage object of the particular object family. The production storage object serves as a production volume that stores host data on behalf of a host.

In some arrangements, performing the object management operation includes creating, as the new object, a snapshot storage object of the production storage object, the snapshot storage object serving as a snapshot of the production volume. After the snapshot storage object is created, the data storage equipment may receive a deletion command to delete the snapshot storage object and, in response to the deletion command, (i) place a set of links for the snapshot storage object in a trashbin of the data storage equipment and (ii) increment the deleted object count for the particular object family. Based on the set of links for the snapshot storage object in the trashbin, the data storage equipment may (i) perform a deletion operation that removes the snapshot from the data storage equipment and (ii) decrement the deleted object count for the particular object family.

In some arrangements, performing the object management operation includes creating, as the new object, a clone storage object of the production storage object, the clone storage object serving as a clone of the production volume. After the clone storage object is created, the data storage equipment may receive a deletion command to delete the clone storage object and, in response to the deletion command, (i) place a set of links for the clone storage object in a trashbin of the data storage equipment and (ii) increment the deleted object count for the particular object family. Based on the set of links for the clone storage object in the trashbin, the data storage equipment may (i) perform a deletion operation that removes the clone from the data storage equipment and (ii) decrement the deleted object count for the particular object family.

In some arrangements, the data storage equipment includes multiple storage processors that perform host input/output (I/O) operations on the particular object family in response to data storage commands from a set of hosts. Additionally, the production storage object of the particular object family is created by a particular storage processor of the multiple storage processors. Furthermore, the method further includes designating the particular storage processor among the multiple storage processors to exclusively perform deletion processing for the particular object family. Such operation enables effective balancing of deletion processing work within the data storage equipment.

In some arrangements, the data storage equipment maintains a plurality of object families on behalf of a set of hosts. Additionally, each object family of the plurality of object families includes a production volume, a set of production volume clones, a set of snapshots, and a set of clones of snapshots. Furthermore, the method further includes performing host I/O operations on the plurality of object families in response to data storage commands from the set of hosts.

In some arrangements, the method further includes delaying deletion processing that removes deleted storage objects from the data storage equipment until the data storage equipment is idle with respect to servicing the host I/O operations. Accordingly, host I/O operations are still effectively prioritized over deletion processing to maximize host I/O processing performance.

In some arrangements, the method further includes:
(A) receiving a second request to create a new object for a second object family that is different from the particular object family;
(B) deriving, for the second object family, a second total object count based on an active object count and a deleted object count for the second object family; and
(C) in response to the second request, performing a second object management operation that (i) creates the new object when the second total object count is less than the predefined total object count threshold and (ii) prevents creation of the new object when the second total object count is not less than the predefined total object count threshold.
   Accordingly, the data storage equipment is able to manage object effectively for multiple object families simultaneously.

Another embodiment is directed to data storage equipment which includes memory, and control circuitry coupled to the memory. The memory stores instructions which, when carried out by the control circuitry, cause the control circuitry to:
(A) receive a request to create a new object for a particular object family,
(B) derive, for the particular object family, a total object count based on an active object count and a deleted object count for the particular object family, and
(C) in response to the request, perform an object management operation that (i) creates the new object when the total object count is less than a predefined total object count threshold and (ii) prevents creation of the new object when the total object count is not less than the predefined total object count threshold.

Yet another embodiment is directed to a computer program product having a non-transitory computer readable medium which stores a set of instructions to manage objects. The set of instructions, when carried out by computerized circuitry, causes the computerized circuitry to perform a method of:
(A) receiving a request to create a new object for a particular object family;
(B) deriving, for the particular object family, a total object count based on an active object count and a deleted object count for the particular object family; and
(C) in response to the request, performing an object management operation that (i) creates the new object when the total object count is less than a predefined total object count threshold and (ii) prevents creation of the new object when the total object count is not less than the predefined total object count threshold.

It should be understood that, in the cloud context, at least some of electronic circuitry is formed by remote computer resources distributed over a network. Such an electronic environment is capable of providing certain advantages such as high availability and data protection, transparent operation and enhanced security, big data analysis, etc.

Other embodiments are directed to electronic systems and apparatus, processing circuits, computer program products, and so on. Some embodiments are directed to various methods, electronic components and circuitry which are involved in managing objects within data storage equipment using a predefined object limit for an object family.

### BRIEF DESCRIPTION OF THE DRAWINGS

The foregoing and other objects, features and advantages will be apparent from the following description of particular embodiments of the present disclosure, as illustrated in the accompanying drawings in which like reference characters refer to the same parts throughout the different views. The drawings are not necessarily to scale, emphasis instead being placed upon illustrating the principles of various embodiments of the present disclosure.

FIG. 1 is a block diagram of a data storage environment having data storage equipment which manages objects using a predefined object limit for an object family.

FIG. 2 is a flowchart of a procedure which is performed by the data storage equipment.

FIG. 3 is a block diagram of a table (or dataset) that is utilized by the data storage equipment.

FIG. 4 is a block diagram illustrating particular details of the data storage equipment during certain operations.

FIG. 5 is another block diagram illustrating particular details of the data storage equipment during other operations.

FIG. 6 is a block diagram of electronic circuitry which is suitable for use as at least a portion of the data storage equipment of FIG. 1.

### DETAILED DESCRIPTION

An improved technique is directed to managing objects within data storage equipment by imposing a predefined object limit on an object family. That is, the data storage equipment prevents the number of objects within the object family from exceeding a predefined maximum number. Accordingly, once the total number of data storage objects in the object family (e.g., a production volume, related snapshots, related clones, related snapshots of clones, etc.) reaches the predefined object limit, any further request to create a new data storage object in that object family is rejected by the data storage equipment. As a result, the amount of deletion processing for that object family is capped and the data storage equipment will not become overextended.

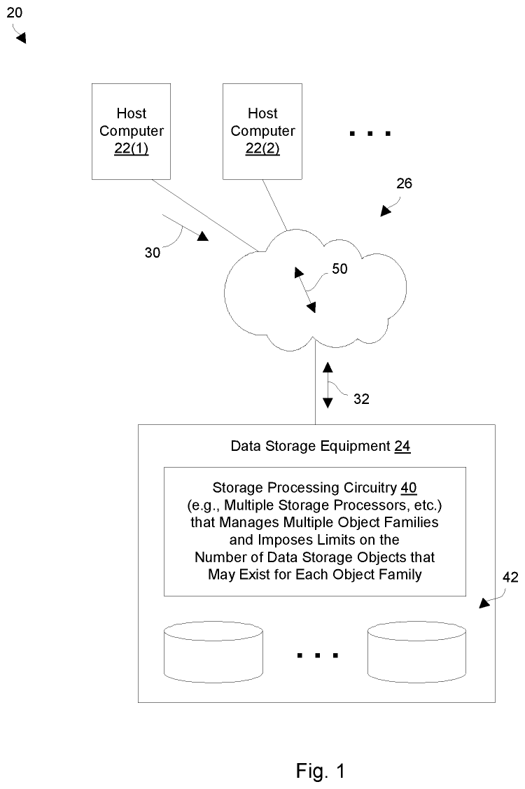

FIG. 1 shows a data storage environment 20 having data storage equipment which manages objects using a predefined object limit for an object family. The data storage environment 20 includes host computers 22(1), 22(2), . . . (collectively, host computers 22), data storage equipment 24, and a communications medium 26.

Each host computer 22 is constructed and arranged to perform useful work. For example, one or more of the host computers 22 may operate as a file server, a web server, an email server, an enterprise server, a database server, a transaction server, combinations thereof, etc. which provides host input/output (I/O) requests 30 to the data storage equipment 24. In this context, the host computers 22 may provide a variety of different I/O requests 30 (e.g., write commands, read commands, combinations thereof, etc.) that direct the data storage equipment 24 to store host data 32 within and retrieve host data 32 from storage (e.g., primary storage or main memory, secondary storage or non-volatile memory, tiered storage, combinations thereof, etc.).

The data storage equipment 24 includes storage processing circuitry 40 and storage devices 42. The storage processing circuitry 40 is constructed and arranged to respond to the host I/O requests 30 from the host computers 22 by writing host data 32 into the storage devices 42 and reading host data 32 from the storage devices 42 (e.g., solid state drives, magnetic disk drives, combinations thereof, etc.). The storage processing circuitry 40 may include one or more physical storage processors or engines, data movers, director boards, blades, I/O modules, storage device controllers, switches, other hardware, combinations thereof, and so on. While processing the host I/O requests 30, the storage processing circuitry 40 is constructed and arranged to provide a variety of specialized data storage services and features such as caching, storage tiering, deduplication, compression, encryption, mirroring and/or other RAID protection, snapshotting, backup/archival services, replication to other data storage equipment, and so on.

As will be explained in further detail shortly, the storage processing circuitry 40 is constructed and arranged to manage multiple object families (i.e., groups of related data storage objects stemming from original objects), and impose a predefined object limit on the total number of objects that may exist in an object family. Since the total number of objects in the object family is capped, there is an upper limit on the amount of deletion processing work that the data storage equipment 24 may need to perform for that object family.

Along these lines, when the total object count (active storage objects in use plus deleted storage objects that have not yet been removed) for an object family has reached the limit, the data storage equipment 24 may deny requests to create additional storage objects in that object family until after the data storage equipment 24 has performed deletion processing that reduces the total object count for that object family back below the limit. Accordingly, the data storage equipment 24 will not become overextended in accumulated deletion processing (or cleanup work) for that object family.

The communications medium 26 is constructed and arranged to connect the various components of the data storage environment 20 together to enable these components to exchange electronic signals 50 (e.g., see the double arrow 50). At least a portion of the communications medium 26 is illustrated as a cloud to indicate that the communications medium 26 is capable of having a variety of different topologies including backbone, hub-and-spoke, loop, irregular, combinations thereof, and so on. Along these lines, the communications medium 26 may include copper-based data communications devices and cabling, fiber optic devices and cabling, wireless devices, combinations thereof, etc. Furthermore, the communications medium 26 is capable of supporting LAN-based communications, SAN-based communications, cellular communications, WAN-based communications, distributed infrastructure communications, other topologies, combinations thereof, etc.

During operation, the storage processing circuitry 40 of the data storage equipment 24 performs data storage operations in response to host I/O requests 30 from the host computers 22. For example, the storage processing circuitry 40 may create, as an initial data storage object, a production volume to store current host data for a host application. Over time, the storage processing circuitry 40 may create related data storage objects such as snapshots of the production volume in accordance with a snapshot schedule or manual commands from a human administrator, clones of the production volume, clones of the snapshots, and so on. This collection of the production volume, its snapshots, its clones, etc. is referred to as an object family because each of these data storage objects stems from an initially created data storage object (e.g., an original production volume).

Additionally, over time, the storage processing circuitry 40 may delete data storage objects of an object family. Along these lines, the storage processing circuitry 40 may periodically delete a snapshot in accordance with a snapshot retention rule (e.g., by only maintaining the last five snapshots, by discarding snapshots that are older than a week, etc.), delete a snapshot or clone in response to a manual command from a human administrator, and so on.

To delete data storage objects, the storage processing circuitry 40 places links (or “tops”) for the data storage objects in a designated location (or “trashbin”) and hides the data storage objects from the host computers 22 to prevent further access. When the storage processing circuitry 40 has no host I/O requests 30 or higher priority tasks left to process (i.e., the storage processing circuitry 40 is idle from the perspective of host I/O requests 30), a dedicated background service within the storage processing circuitry 40 performs deletion processing based on the links that were placed in the trashbin. Such deletion processing removes the data storage objects from the data storage equipment 24 so that the storage space and other resources consumed by the data storage object are formally reclaimed and available for reuse.

During such operation, the storage processing circuitry 40 monitors the total number of objects that exist within the data storage equipment 24 for an object family. This total number of objects equals the sum of active objects (i.e., data storage objects that are considered “in use” and not deleted within the data storage equipment 24) and deleted data storage objects that have not yet been removed from the data storage equipment 24 (i.e., data storage objects that are considered “no longer in use” and thus hidden from the host computers 22 but that still consume resources that have not yet been reclaimed within the data storage equipment 24). If the total number of objects for an object family is less than a predefined threshold, the storage processing circuitry 40 is allowed to create a new object for that object family when requested. However, if the total number of objects for the object family is not less than the predefined threshold, the storage processing circuitry 40 is not allowed to create a new object for that object family when requested. That is, if the total number of objects for the object family is at the predefined threshold, the storage processing circuitry 40 will reject requests to create new objects for that object family until the total number of objects for the object family drops below the predefined threshold. Such operation prevents the data storage equipment 24 from becoming overextended due to over-accumulation of deletion processing work for that object family.

It should be understood that application of such a predefined total object count threshold may be extended to multiple object families. That is, the predefined threshold may be imposed on multiple object families simultaneously (e.g., object families for a particular application, object families managed by a particular set of host computers 22, object families that store a particular type of data, all object families, etc.). Moreover, the predefined threshold may be different and/or adjusted for different object families. Nevertheless, such use of one or more predefined thresholds imposes control over the amount of deletion processing work that accumulates within the data storage equipment 24.

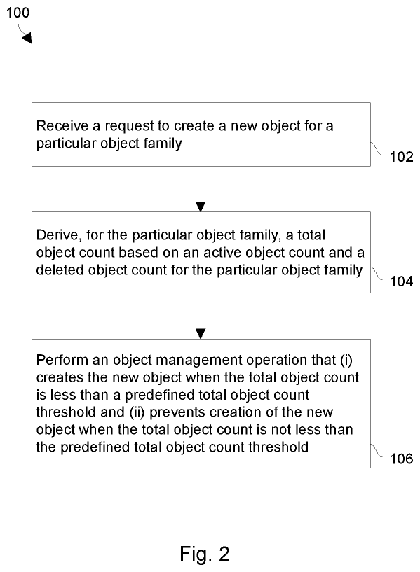

To distinguish different object families from each other, the data storage equipment 24 uniquely identifies each object family via a respective object family identifier (ID) (e.g., a number, an alphanumeric string, a hexadecimal value or key, etc.). Further details will now be provided with reference to FIG. 2.

FIG. 2 is a flowchart of a procedure 100 for managing data storage objects which is performed by circuitry of the data storage equipment 24 (e.g., mapping circuitry) to prevent excessive accumulation of deletion processing work. Such a procedure 100 may be performed while the data storage equipment 24 concurrently performs data storage operations (e.g., processes host I/O requests 30) on behalf of a set of host computers 22 (also see FIG. 1).

At 102, the circuitry receives a request to create a new object for a particular object family. For example, the circuitry may receive requests to create snapshots of a production volume in accordance with a snapshot schedule. As another example, the circuitry may receive a request to clone the production volume or a snapshot for capturing milestone data, testing, debugging, etc. The circuitry may receive requests to create data storage objects for other reasons as well, e.g., migration, forensics, compliance verification, research, and so on.

At 104, the circuitry derives, for the particular object family, a total object count (TOC) based on an active object count (AOC) and a deleted object count (DOC) for the particular object family. In particular, the circuitry identifies, as the AOC, the number of active objects of the particular object family that currently reside within the data storage equipment 24. As mentioned earlier, such active objects are visible to and may be accessed by the host computers 22.

Additionally, the circuitry identifies, as the DOC, the number of deleted objects of the particular object family that currently reside within the data storage equipment 24 (recall that processing of deleted objects may be delayed to prioritize host I/O request 30 processing ahead of deletion processing). As mentioned earlier, such deleted objects are no longer visible to and cannot be accessed by the host computers 22. Rather, the deleted objects still consume resources (e.g., memory, mapping resources, error protection resources, etc.) and are awaiting deletion processing in order to free those resources. Once the circuitry has removed a deleted object and reclaimed the resources for reuse, the DOC is appropriately decremented.

To derive the TOC, the circuitry aggregates the AOC and DOC as shown in Equation (1) below.

TOC=AOC+DOC (1)

As will be explained in further detail shortly, one or more of these values may be stored persistently within a table that is indexed by object family identifiers (IDs).

Such a computation may be event driven (e.g., performed in response to the request to create the new data storage object). Additionally and/or alternatively, such a computation may be performed periodically in the background (e.g., within short enough time windows to prevent the TOC from inadvertently or grossly exceeding the predefined object limit.

At 106, the circuitry performs, in response to the request, an object management operation that (i) creates the new object when the total object count is less than a predefined total object count threshold and (ii) prevents creation of the new object when the total object count is not less than the predefined total object count threshold. Accordingly, deletion processing debt accumulation for the object family remains reliably controlled.

Such operation provides for effective trash accounting for deleted objects in a storage volume family. Thus, trash debt for the storage volume family is effectively limited.

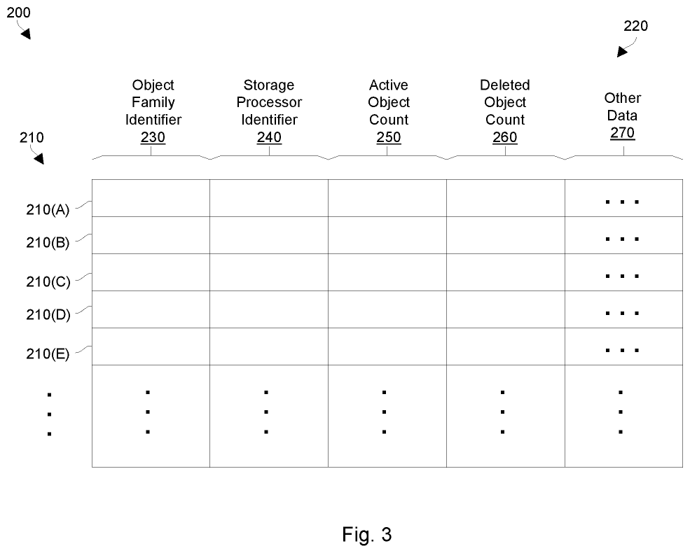

It should be understood that the circuitry may perform the procedure 100 for multiple object families. As a result, the data storage equipment 24 is safeguarded against becoming overextended with accumulated deletion work. Further details will now be provided with reference to FIG. 3.

FIG. 3 shows a table (or dataset) 200 that, among other things, monitors deleted object counts. The table 200 includes a series of object family entries 210(A), 210(B), 210(C), 210(D), 210(E), . . . (collectively, object family entries 210) that identify respective object families (i.e., groups of related data storage objects) that are maintained by the data storage equipment 24 (also see FIG. 1).

Each object family entry 210 of the table 200 includes a group of fields 220 such as an object family ID field 230, a storage processor field 240, an active object count field 250, and a deleted object count field 260. Each object family entry 210 may include other fields 270 as well (e.g., a timestamp field, a total object count field, etc.).

The object family ID field 230 of an object family entry 210 includes an object family ID that uniquely identifies a particular object family within the data storage equipment 24. In accordance with certain embodiments, the object family IDs further operate as indexes that address the various entries 210 of the table 200. For example, a first object family may have “1” as the object family identifier which also indexes the first object family entry in the table 200. Similarly, a second object family may have “2” as the object family identifier which also indexes the second object family entry in the table 200, and so on.

The storage processor field 240 of an object family entry 210 identifies a particular storage processor (SP) that originally created (or established) the object family identified by that object family entry 210 (identified by the object family ID in the object family entry 210). In accordance with certain embodiments, such SP identification enables the deletion work for a particular object family to be assigned to the same SP that originally created the object family. Along these lines, it should be appreciated that the storage processing circuitry 40 of the data storage processor 24 (also see FIG. 1) may include multiple SPs for load balancing purposes, fault tolerance, etc. For example, storage processor A may create a first object family, storage processor B may create a second storage object family, and so on.

The active object count field 250 of an object family entry 210 identifies an active object count (AOC) for the object family identified by that object family entry 210.

Recall that the AOC is the number of active data storage objects (a production volume, snapshots, clones, clones of snapshots, etc.) that currently exist within the data storage equipment 24. The AOC for a particular object family is incremented each time a new data storage object is created in the object family. Additionally, the AOC for a particular object family is decremented each time an active data storage object is deemed (or labeled) as deleted from the object family (e.g., where the set of links for that object are moved to the trashbin).

The deleted object count field 260 of an object family entry 210 identifies a deleted object count (DOC) for the object family identified by that object family entry 210. Recall that the DOC is the number of deleted data storage objects that still exist within the data storage equipment 24 and await deletion processing. The DOC for a particular object family is incremented each time an active data storage object is deemed (or labeled) as deleted in the object family. Additionally, the DOC for a particular object family is decremented each time deletion processing is performed on a deleted data storage object of the object family to properly remove the data storage object and reclaim the data storage resources that were consumed by the data storage object while the data storage object was active.

The other fields 270 of an object family entry 210 may provide additional information regarding the object family identified by that object family entry 210. For example, certain content of the other fields 270 may identify when the object family entry 210 was last updated, a total object count for the object family (e.g., see Equation (1) above), and so on.

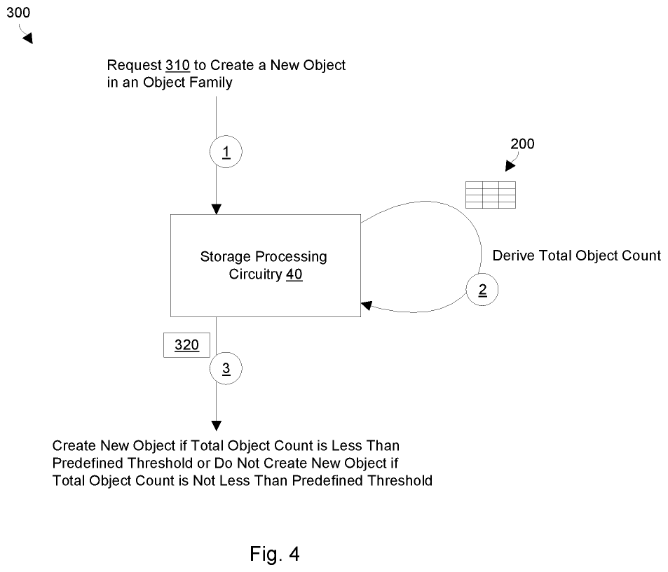

In accordance with certain embodiments, the table 200 is a dataset having portions distributed among other data structures within the data storage equipment. That is, the data with the table 200 may be a collection of related but separate sets of information that can be manipulated as a unit. For example, certain fields of the table 200 (i.e., the object family identifier field 230 and deleted object count field 260 may reside in a flat table perhaps located in the root area) while other fields of the table 200 reside in other data structures. Other configurations are suitable for use as well (e.g., a single table at a central location, a completely distributed dataset, portions distributed among different databases/repositories/constructs, etc.). Further details will now be provided with reference to FIG. 4.

FIG. 4 illustrates details of certain operations performed by the storage processing circuitry 40 of the data storage equipment 24 when managing objects using a predefined total object count threshold for an object family (also see FIG. 1). Such operations utilize information from the table 200 (also see FIG. 3).

First, the storage processing circuitry 40 receives a request 310 to create a new object in a particular object family (arrow 1). By way of example only, such a request 310 may be in response to a scheduled snapshotting event to create a snapshot of a production volume. However, it should be understood that such a request 310 may originate from a different event (e.g., a user command to create a clone of another data storage object, etc.).

Next, the storage processing circuitry 40 evaluates the total object count (TOC) for the particular object family (arrow 2). If the TOC has not yet been calculated, the storage processing circuitry 40 reads appropriate information from data structures within the data storage equipment 24 (e.g., see the table 200 in FIG. 3) to obtain the active object count (AOC) and the deleted object count (DOC), and aggregates the AOC and the DOC to obtain the TOC (also see Equation (1)).

Then, the storage processing circuitry 40 compares the TOC to the predefined total object count threshold 320 to determine whether to create the new object in response to the request 310 or reject the request 310 (arrow 3). In some arrangements, the threshold 320 is a global limit that applies to all object families. In other arrangements, the threshold 320 is specific (or custom) to a set of object families (one or more) but not all of the object families within the data storage equipment 24. Such a threshold 320 may be set to an initial default value but later adjusted (e.g., tuned over time, changed by a human administrator, combinations thereof, etc.).

If the TOC is not less than the predefined total object count threshold 320, the storage processing circuitry 40 does not create the new object and rejects the request 310. However, if the TOC is less than the threshold 320, the storage processing circuitry 40 creates the new object, e.g., a new snapshot of the production volume. As part of the object creation process, the storage processing circuitry 40 increments the AOC for the object family.

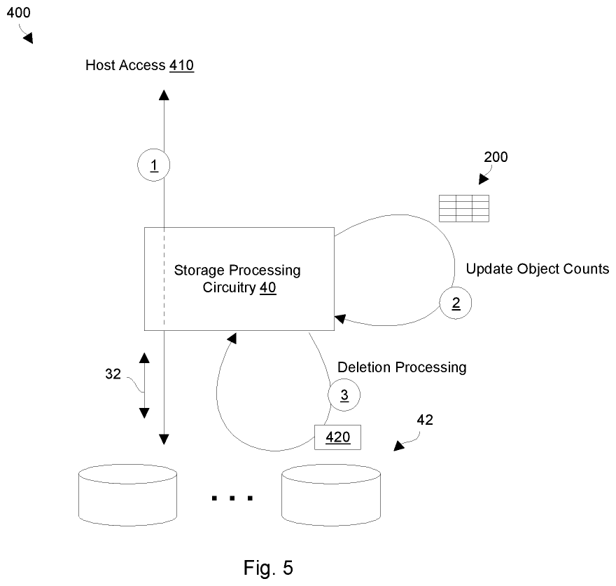

As mentioned earlier, such operation may be performed for multiple object families. In accordance with certain embodiments, the storage processing circuitry 40 includes multiple SPs, and the particular SP that originally created the object family handles requests for creating new objects for that object family for load balancing purposes. Further details will now be provided with reference to FIG. 5.

FIG. 5 illustrates details of certain other operations performed by the storage processing circuitry 40 of the data storage equipment 24 (also see FIG. 1). Such operations may involve further accessing the table 200 (also see FIG. 3).

In accordance with certain embodiments, the primary function of the storage processing circuitry 40 is to provide host access 410 to host data 32 stored on the storage devices 42 (arrow 1) (also see FIG. 1). Such operation may involve processing host I/O requests 30 from a set of host computers 22. Here, the storage processing circuitry 40 writes host data 32 to the storage devices 42, and reads host data 32 from the storage devices 42 in response to the host I/O requests 30. However, one should appreciate that the data storage equipment 24 may perform other primary data storage tasks in addition to servicing host I/O requests 30 or in the alternative such as operate as a remote replication site to replicate data storage objects from other data storage equipment 24, record data from a set of data sensors, cache content as part of a content distribution network (CDN), and so on.

During such operation, the storage processing circuity 40 may create new objects and/or delete existing objects for a particular object family. As mentioned earlier, when the storage processing circuity 40 creates a new object, the storage processing circuity 40 increments the AOC for the object family so that the AOC accurately reflects the number of active objects in the object family. Additionally, when the storage processing circuity 40 deletes an existing object, the storage processing circuity 40 decrements the AOC for the object family and increments the DOC for the object family so that the AOC continues to accurately reflect the number of active objects in the object family and the DOC continues to accurately reflect the number of deleted objects that have not been fully deleted in the object family (arrow 2).

When the storage processing circuity 40 is idle (e.g., not processing host I/O requests 30), the storage processing circuitry 40 may perform administrative work such as deletion processing that reclaims resources consumed by deleted objects that have not been removed from the data storage equipment 24 (arrow 3). To this end, a background service may retrieve links (or tops) for the deleted objects from a trashbin 420. The background service then uses the links to locate storage locations within the storage devices 42 to be reclaimed and ultimately reused. Such operation frees up storage and related resources that were consumed. When an object of an object family has been fully deleted and the consumed resources have been reclaimed, the storage processing circuity 40 decrements the DOC so that the DOC continues to accurately reflect the number of deleted objects that have not been fully deleted in the object family.

In accordance with certain embodiments, the storage processing circuitry 40 includes multiple SPs, and the particular SP that originally created the object family handles deletion work for that object family. Such assignment may facilitate control and/or ownership over certain resources, provide load balancing, and so on.

Additionally, in accordance with some embodiments, when the storage processing circuity 40 is ready to perform deletion processing, the storage processing circuity 40 performs a deletion assessment operation that selects a target object family from multiple object families having deleted objects awaiting deletion processing. In particular, the storage processing circuity 40 may select the target object family based on which deletion processing will provide the largest benefit in terms of reclaiming data storage resources. Once the storage processing circuity 40 selects the target object family among other object families, the storage processing circuity 40 performs deletion processing on the deleted objects of that object family ahead of others.

In some arrangements, the storage processing circuity 40 performs deletion processing on deleted objects in a discriminatory manner. For example, the storage processing circuity 40 may perform the deletion assessment operation to identify a priority order for performing deletion processing to optimize the benefits of the deletion processing work.

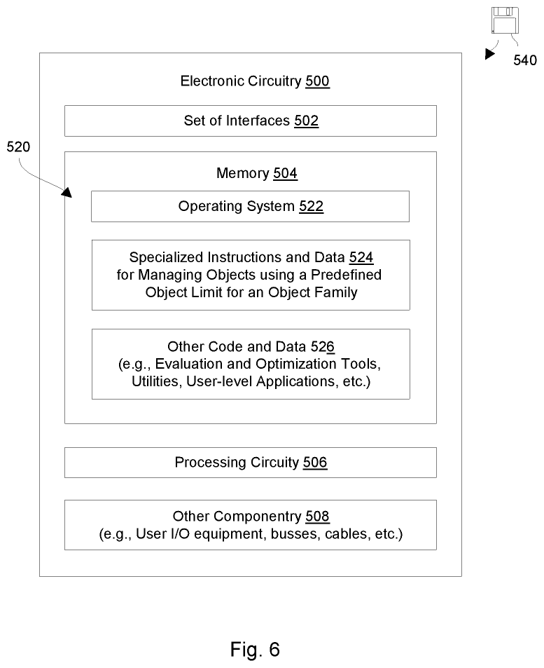

In other arrangements, the storage processing circuity 40 performs deletion processing on deleted objects in a non-discriminatory manner when the data storage equipment 24 is fully healthy. For example, the storage processing circuity 40 may processes deleted objects identified by links in trashbin in a first-in/first-out (FIFO) order, in a randomized order, etc. However, if the data storage equipment 24 becomes unhealthy (e.g., short on one or more critical resources), the storage processing circuity 40 switches to performing deletion processing on deleted objects in the discriminatory manner. Further details will now be provided with reference to FIG. 6.

FIG. 6 shows electronic circuitry 500 which is suitable for at least a portion of the data storage equipment 24 (also see FIG. 1). The electronic circuitry 500 includes a set of interfaces 502, memory 504, and processing circuitry 506, and other circuitry 508.

The set of interfaces 502 is constructed and arranged to connect the electronic circuitry 500 to the communications medium 26 (also see FIG. 1) to enable communications with other devices of the data storage environment 20 (e.g., the host computers 22). Such communications may be IP-based, SAN-based, cellular-based, cable-based, fiber-optic based, wireless, cloud-based, combinations thereof, and so on. Accordingly, the set of interfaces 502 may include one or more host interfaces (e.g., a computer network interface, a fibre-channel interface, etc.), one or more storage device interfaces (e.g., a host adapter or HBA, etc.), and other interfaces. As a result, the set of interfaces 502 enables the electronic circuitry 500 to robustly and reliably communicate with other external apparatus.

The memory 504 is intended to represent both volatile storage (e.g., DRAM, SRAM, etc.) and non-volatile storage (e.g., flash memory, magnetic memory, etc.). The memory 504 stores a variety of software constructs 520 including an operating system 522, specialized instructions and data 524, and other code and data 526. The operating system 522 refers to particular control code such as a kernel to manage computerized resources (e.g., processor cycles, memory space, etc.), drivers (e.g., an I/O stack), and so on. The specialized instructions and data 524 refers to particular control code for managing objects using a predefined total object count threshold for an object family. In some arrangements, the specialized instructions and data 524 is tightly integrated with or part of the operating system 522 itself. The other code and data 526 refers to applications and routines to provide additional operations/services (e.g., performance measurement tools, etc.), user-level applications, administrative tools, utilities, and so on.

The processing circuitry 506 is constructed and arranged to operate in accordance with the various software constructs 520 stored in the memory 504. As described herein, the processing circuitry 506 executes the operating system 522 and the specialized code 524 to form specialized circuitry that robustly and reliably manages host data on behalf of a set of hosts. Such processing circuitry 506 may be implemented in a variety of ways including via one or more processors (or cores) running specialized software, application specific ICs (ASICs), field programmable gate arrays (FPGAs) and associated programs, discrete components, analog circuits, other hardware circuitry, combinations thereof, and so on. In the context of one or more processors executing software, a computer program product 540 is capable of delivering all or portions of the software constructs 520 to the electronic circuitry 500. In particular, the computer program product 540 has a non-transitory (or non-volatile) computer readable medium which stores a set of instructions that controls one or more operations of the electronic circuitry 500. Examples of suitable computer readable storage media include tangible articles of manufacture and apparatus which store instructions in a non-volatile manner such as DVD, CD-ROM, flash memory, disk memory, tape memory, and the like.

The other componentry 508 refers to other hardware of the electronic circuitry 500. Along these lines, the electronic circuitry 500 may include special user I/O equipment (e.g., a service processor), busses, cabling, adaptors, transducers, auxiliary apparatuses, other specialized data storage componentry, etc.

It should be understood that the processing circuitry 506 operating in accordance with the software constructs 520 enables formation of certain specialized circuitry that manages data storage objects using a predefined object limit for an object family. Alternatively, all or part of such circuitry may be formed by separate and distinct hardware.

As described above, improved techniques are directed to managing objects within data storage equipment 24 using a predefined object limit 320 for an object family (e.g., a maximum number of data storage objects in the object family that may exist at any time). In particular, once the total number of data storage objects in the object family (e.g., a production volume, related snapshots, related clones, related snapshots of clones, etc.) reaches the predefined object limit 320, any further request to create a new data storage object in that object family is rejected by the data storage equipment 24. Accordingly, the amount of deletion processing for that object family is capped and the data storage equipment 24 will not become overextended.

One should appreciate that the above-described techniques do not merely create and delete objects. Rather, the disclosed techniques involve techniques which prevent data storage equipment 24 from becoming overextended in terms of accumulated deletion processing debt which could then interfere with certain operations such as mapping, metadata recovery, etc. Additionally, such techniques safeguard against such debt accumulation causing the breaking of child-parent link limits, problems with consistency check (e.g., fsck) times, memory shortages, and so on.

While various embodiments of the present disclosure have been particularly shown and described, it will be understood by those skilled in the art that various changes in form and details may be made therein without departing from the spirit and scope of the present disclosure as defined by the appended claims.

For example, it should be understood that various components of the data storage environment 20 such as the host computers 22 are capable of being implemented in or “moved to” the cloud, i.e., to remote computer resources distributed over a network. Here, the various computer resources may be distributed tightly (e.g., a server farm in a single facility) or over relatively large distances (e.g., over a campus, in different cities, coast to coast, etc.). In these situations, the network connecting the resources is capable of having a variety of different topologies including backbone, hub-and-spoke, loop, irregular, combinations thereof, and so on. Additionally, the network may include copper-based data communications devices and cabling, fiber optic devices and cabling, wireless devices, combinations thereof, etc. Furthermore, the network is capable of supporting LAN-based communications, SAN-based communications, combinations thereof, and so on.

Additionally, in some arrangements, hosts may be located or integrated within the data storage equipment itself. Such unified operation still may rely on managing objects using a predefined object limit 320 for an object family, as disclosed herein.

Moreover, the notion of SPs were described herein. Such SPs may be physical SPs (i.e., separate hardware devices) for circuitry redundancy/fault tolerance. Alternatively or additionally, such SPs may be virtual for flexibility (e.g., load balancing, scalability, maintenance simplification, etc.).

The individual features of the various embodiments, examples, and implementations disclosed within this document can be combined in any desired manner that makes technological sense. Furthermore, the individual features are hereby combined in this manner to form all possible combinations, permutations and variants except to the extent that such combinations, permutations and/or variants have been explicitly excluded or are impractical. Support for such combinations, permutations and variants is considered to exist within this document.

It should be understood that, to deliver best performance in storage arrays, computing resources are managed in a way to prefer host IO over tasks such as space reclamation from deleted storage objects. However, such preference potentially creates a debt that can be prioritized during idle time, but this debt accumulation cannot be unlimited for multiple reasons such as mapping, metadata, recovery and storage constraints. Therefore, there is a need in conventional data storage systems for a solution that tracks debt in a data storage system to honor all system constraints but also minimize impact on host 10.

In accordance with certain embodiments disclosed herein, improved techniques provide trash accounting for deleted objects in a storage volume family. To track deleted object debt in system, the techniques create a flat table that accounts and keeps track of object count on per family basis (FamilyTrashDebt Table).

In a storage system there are pre-defined number of volume object families. A volume object family is defined as collective group of production volume, its clones, its snaps and snaps of those clones. In certain systems these volume object families are referred as snapgroups, lifetime max number of snapgroups in such a system is a predefined value (e.g., 128K, 256K, 512K, etc.).

All the objects in a snap group family share a unique key called SnapID. The techniques may use this as key to build a table that accounts for number of objects that are deleted but haven't been trash processed.

Accounting in this table is then used to process the debt with minimal impact on host IO by prioritizing host IO over background debt processing by delaying debt processing to happen when the system is idle rather than at the time of delete itself.

How this table is created, updated and referred will now be explained. When a delete of storage object is flushed to mapper all tops are accumulated into a metadata page called volume trash debt page with SnapID of the object saved in the page and it is added as payload into the trashbin. For each volume trash debt page that is added into trashbin an increment of trash debt count for corresponding SnapID is done in the table.

When trashbin processing happens in background and completes, processing of all tops in a volume trash debt page then does a decrement of trash debt count for corresponding SnapID in the table. This how pending debt in trash is accounted for deleted objects, therefore when a new object create request (e.g., for a snap or clone) is issued, the total object count in that family is determined using active volume count +trash debt volume count that is accounted in table.

In connection with conventional data storage systems, it should be appreciated that there is currently no limit enforced on the number of family snaps. When a snap is deleted, the tops are moved into the trashbin. Even if an active snap count per family is maintained and then decremented in response to the deletion of the snap, the snap still has not been removed. There is still a debt in terms of resources used and in terms of processing needed which may hinder flush (e.g., break a child-parent link limit) or impede total fsck time if objects require recovery.

In accordance with certain embodiments, a mapper tracks the number of snaps per family that are still in the trashbin and generates a total count which includes an active snap count. This total count limited by a maximum or limit is enforced if a new snap is to be created (e.g., by the control path/name space). In particular, if the total snap count (active+trashbin) reaches L snaps per family (e.g., L=5K), then any request for a new snap is rejected.

By way of example, the data storage equipment may support an overall maximum number of unique family IDs M (e.g., 128K, 256K, 512K, etc.). Additionally, the data storage equipment enforces a snap (or object) limit of L snaps (or objects) per family ID (e.g., 4K, 5K, 6K, etc.).

Each snap can potentially have multiple tops (or links for the data).

In certain embodiments, a family ID table (T1) of M entries is maintained from the boot tier. Each entry has the trashbin snap count. Such a table may be persistently maintained in the boot tier.

In some embodiments, the family IDs in the mapper are allocated and reused as normal integers ranging from 1 to 256K. Accordingly, the family IDs may be used as indexes into the table to evaluate if a new snap can be allowed for a new volume addition into an existing snap family. Such modifications and enhancements are intended to belong to various embodiments of the disclosure.

What is claimed is:

1. In data storage equipment, a method of managing objects, the method comprising:
receiving a request to create a new object for a particular object family;
deriving, for the particular object family, a total object count based on an active object count and a deleted object count for the particular object family; and
in response to the request, performing an object management operation that (i) creates the new object when the total object count is less than a predefined total object count threshold and (ii) prevents creation of the new object when the total object count is not less than the predefined total object count threshold.

2. A method as in claim 1 wherein deriving the total object count includes:
identifying, as the active object count, a first number of active objects of the particular object family that currently reside within the data storage equipment,
identifying, as the deleted object count, a second number of deleted objects of the particular object family that currently reside within the data storage equipment, and
aggregating the first number of active objects and the second number of deleted objects to form the total object count.

3. A method as in claim 2 wherein the data storage equipment maintains a deleted object count table having deleted object count entries, each deleted object count entry of the deleted object count table (i) being indexed by a family identifier that uniquely identifies a respective object family and (ii) storing a respective deleted object count;
wherein identifying the second number of deleted objects of the particular object family includes:
identifying a particular deleted object count entry of the deleted object count table based on a particular object family identifier that uniquely identifies the particular object family among a plurality of object families within the data storage equipment, and
reading, as the second number of deleted objects, the respective deleted object count stored in the particular deleted object count entry.

4. A method as in claim 3, further comprising:
updating the respective deleted object count stored in the particular deleted object count entry to indicate a current number of objects of the particular object family that have been deleted from a perspective of a host but that still await deletion processing within the data storage equipment.

5. A method as in claim 3, further comprising:
performing a deletion assessment operation that selects a target object family from the plurality of object families for prioritized deletion processing based on deleted object counts stored in the deleted object count entries of the deleted object count table.

6. A method as in claim 1, further comprising:
prior to receiving the request to create the new object for the particular object family and prior to deriving the total object count, creating a production storage object of the particular object family, the production storage object serving as a production volume that stores host data on behalf of a host.

7. A method as in claim 6 wherein performing the object management operation includes:
creating, as the new object, a snapshot storage object of the production storage object, the snapshot storage object serving as a snapshot of the production volume.

8. A method as in claim 7, further comprising:
after the snapshot storage object is created, receiving a deletion command to delete the snapshot storage object, and
in response to the deletion command, (i) placing a set of links for the snapshot storage object in a trashbin of the data storage equipment and (ii) incrementing the deleted object count for the particular object family.

9. A method as in claim 8, further comprising:
based on the set of links for the snapshot storage object in the trashbin, (i) performing a deletion operation that removes the snapshot from the data storage equipment and (ii) decrementing the deleted object count for the particular object family.

10. A method as in claim 6 wherein performing the object management operation includes:
creating, as the new object, a clone storage object of the production storage object, the clone storage object serving as a clone of the production volume.

11. A method as in claim 10, further comprising:
after the clone storage object is created, receiving a deletion command to delete the clone storage object, and
in response to the deletion command, (i) placing a set of links for the clone storage object in a trashbin of the data storage equipment and (ii) incrementing the deleted object count for the particular object family.

12. A method as in claim 11, further comprising:
based on the set of links for the clone storage object in the trashbin, (i) performing a deletion operation that removes the clone from the data storage equipment and (ii) decrementing the deleted object count for the particular object family.

13. A method as in claim 6 wherein the data storage equipment includes multiple storage processors that perform host input/output (I/O) operations on the particular object family in response to data storage commands from a set of hosts;
wherein the production storage object of the particular object family is created by a particular storage processor of the multiple storage processors; and
wherein the method further comprises:
designating the particular storage processor among the multiple storage processors to exclusively perform deletion processing for the particular object family.

14. A method as in claim 1 wherein the data storage equipment maintains a plurality of object families on behalf of a set of hosts;
wherein each object family of the plurality of object families includes a production volume, a set of production volume clones, a set of snapshots, and a set of clones of snapshots; and
wherein the method further comprises:
performing host input/output (I/O) operations on the plurality of object families in response to data storage commands from the set of hosts.

15. A method as in claim 14, further comprising:
delaying deletion processing that removes deleted storage objects from the data storage equipment until the data storage equipment is idle with respect to servicing the host I/O operations.

16. A method as in claim 14, further comprising:
receiving a second request to create a new object for a second object family that is different from the particular object family;
deriving, for the second object family, a second total object count based on an active object count and a deleted object count for the second object family; and
in response to the second request, performing a second object management operation that (i) creates the new object when the second total object count is less than the predefined total object count threshold and (ii) prevents creation of the new object when the second total object count is not less than the predefined total object count threshold.

17. Data storage equipment, comprising:
memory; and
control circuitry coupled to the memory, the memory storing instructions which, when carried out by the control circuitry, cause the control circuitry to:
receive a request to create a new object for a particular object family,
derive, for the particular object family, a total object count based on an active object count and a deleted object count for the particular object family, and
in response to the request, perform an object management operation that (i) creates the new object when the total object count is less than a predefined total object count threshold and (ii) prevents creation of the new object when the total object count is not less than the predefined total object count threshold.

18. A computer program product having a non-transitory computer readable medium which stores a set of instructions to manage objects; the set of instructions, when carried out by computerized circuitry, causing the computerized circuitry to perform a method of:
receiving a request to create a new object for a particular object family;
deriving, for the particular object family, a total object count based on an active object count and a deleted object count for the particular object family; and
in response to the request, performing an object management operation that (i) creates the new object when the total object count is less than a predefined total object count threshold and (ii) prevents creation of the new object when the total object count is not less than the predefined total object count threshold.
